(19) United States
(12) Patent Application Publication
(10) Pub. No.: US 2018/0332618 A1
(43) Pub. Date: Nov. 15, 2018

(54) METHOD OF WIRELESS COMMUNICATION AND USER EQUIPMENT

(71) Applicants: DOCOMO INNOVATIONS, INC., Palo Alto, CA (US); NTT DOCOMO, INC., Tokyo (JP)

(72) Inventors: Yuichi Kakishima, Tokyo (JP); Ozgun Bursalioglu-Yilmaz, Palo Alto, CA (US); Hiroki Harada, Tokyo (JP); Satoshi Nagata, Tokyo (JP)

(73) Assignee: NTT DOCOMO, INC., Tokyo (JP)

(21) Appl. No.: 15/773,434

(22) PCT Filed: Nov. 2, 2016
(86) PCT No.: PCT/US2016/060099

§ 371 Date: May 3, 2018

Related U.S. Application Data
(60) Provisional application No. 62/250,941, filed on Nov. 4, 2015.

(51) Int. Cl. H04W 74/08; H04W 16/14; H04L 5/00; H04B 7/06; H04W 72/12

(52) U.S. Cl. CPC H04W 74/0816; H04W 16/14; H04W 72/1215; H04L 5/0055; H04B 7/0626; H04L 5/005

(57) ABSTRACT

A method of wireless communication using an unlicensed band includes performing, with a first transceiver, Listen-Before-Talk (LBT) in the unlicensed band, after the first transceiver has performed the LBT, transmitting a first signal from the first transceiver to a second transceiver in the unlicensed band, and after the first transceiver has transmitted the first signal, transmitting a second signal from the second transceiver to the first transceiver in the unlicensed band without the second transceiver performing the LBT.

### TECHNICAL FIELD

The present invention relates generally to wireless communications and, more particularly, to a method for downlink and uplink transmission in an unlicensed band in a Licensed-Assisted Access (LAA) system.

### BACKGROUND ART

Licensed-Assisted Access (LAA) that expands Long Term Evolution (LTE)-compatible spectrum to unlicensed bands is being studied in Third Generation Partnership Project (3GPP). The unlicensed bands are used in wireless communication such as Wi-Fi (IEEE 802.11 family). An LAA system requires a Listen-Before-Talk (LBT) and transmission with a limited maximum duration of a transmission burst (also called “max burst length”) in the unlicensed bands.

The LBT is a mechanism by which equipment applies a clear channel assessment (CCA) before using a channel in the unlicensed bands. If the channel is determined to be occupied by performing the LBT, the equipment does not transmit a signal in the channel.

To prohibit occupation of the channel in an unlicensed band by the specific equipment, regulations were introduced in some regions such as Europe and Japan to limit the maximum duration of the transmission burst in the unlicensed bands. For example, regulatory requirements in Japan for IEEE 802.11a/n/ac require the maximum duration of a transmission burst as 4 msec or less.

FIG. 1 illustrates a conventional LAA system that performs LBT before transmission in an unlicensed band. If the channel in the unlicensed band is determined to be busy by performing the LBT because other systems (e.g., Wi-Fi) use the channel in the unlicensed band for transmission, the LAA system does not transmit any signals. If the channel in the unlicensed band is determined to be idle by performing the LBT, the LAA system is allowed to transmit signals during a maximum duration of the transmission burst (e.g., 4 msec).

On the other hand, scenarios for LAA that support uplink and downlink transmission in the carrier in the unlicensed bands may require performing the LBT when a switch between uplink and downlink occurs. For example, the aforementioned scenarios may be dual connectivity between a cell in the licensed carrier and a cell in the unlicensed carrier, and standalone.

However, performing the LBT when a switch between uplink and downlink occurs and when the same link signal is continuously or discontinuously transmitted may cause the LAA system to be inefficient by decreasing opportunities for transmission when the LAA system finds the occupied channel in the unlicensed bands. FIG. 2 shows a downlink and uplink transmission in unlicensed bands in the current scenarios for LAA. For example, as shown in FIG. 2, in the LAA system, a base station transmits a downlink (DL) signal (such as a Channel State Information Reference Signal (CSI-RS)) to a user equipment after the base station performs the LBT for a downlink channel (DL LBT). Then the user equipment transmits an uplink (UL) signal such as CSI feedback to the base station in response to the CSI-RS after the user equipment performs the LBT for an uplink channel (UL LBT). On the other hand, even if the user equipment receives the CSI-RS form the base station, the user equipment does not transmit the signal (CSI feedback) if the channel in the unlicensed band is determined to be busy by the UL LBT.

### CITATION LIST

### Non-Patent Reference

[Non-Patent Reference 1] R1-154407 “Discussion on CSI measurement design for LAA DL,” August 2015.

### SUMMARY OF THE INVENTION

According to one or more embodiments of the present invention, a method of wireless communication using an unlicensed band may comprise performing, with a first transceiver, Listen-Before-Talk (LBT) in the unlicensed band, after the first transceiver has performed the LBT, transmitting a first signal from the first transceiver to a second transceiver in the unlicensed band, and after the first transceiver has transmitted the first signal, transmitting a second signal from the second transceiver to the first transceiver in the unlicensed band without the second transceiver performing the LBT.

According to one or more embodiments of the present invention, a user equipment (UE) may comprise a receiver that receives a first signal from a base station (BS) in an unlicensed band, and a transmitter that transmits, to the BS, a second signal in response to the first signal in the unlicensed band, without the UE performing Listen-Before-Talk (LBT).

According to one or more embodiments of the present invention, a method of wireless communication using an unlicensed band may comprise transmitting, from a base station (BS) to a user equipment (UE), Listen-Before-Talk (LBT)-related information indicating whether or not the UE performs LBT, determining, with the UE, whether the UE performs Listen-Before-Talk (LBT) in the unlicensed band based on the LBT-related information, and transmitting, from the UE to the BS, an uplink (UL) data signal.

A method of wireless communication using an unlicensed band according to one or more embodiments of the present invention can improve effectiveness of a transmission in the unlicensed band in the LAA system.

### BRIEF DESCRIPTION OF THE DRAWINGS

FIG. 1 is a diagram showing an LAA system that performs LBT before transmission in an unlicensed band in the conventional technology.

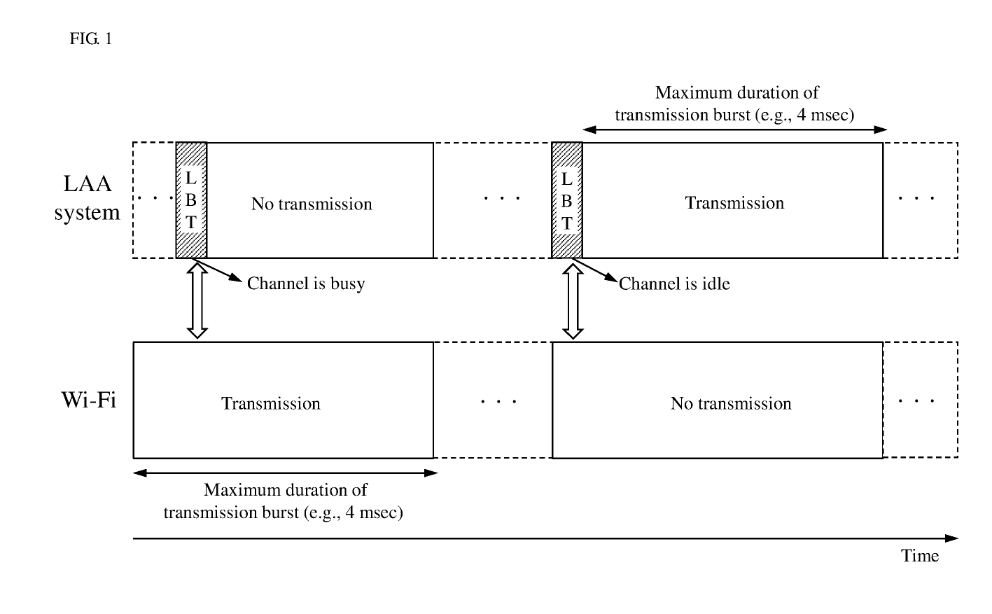

FIG. 2 is a diagram showing a downlink and uplink transmission in the unlicensed band in the current scenarios for LAA.

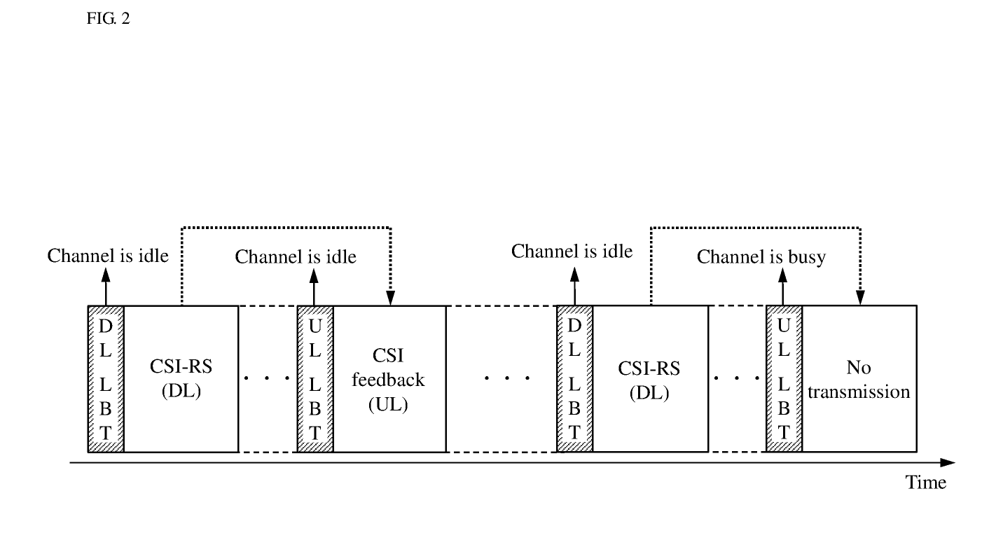

FIG. 3 is a diagram showing a configuration of a wireless communication system according to one or more embodiments of the present invention.

FIG. 4 is a sequence diagram showing a downlink and uplink transmission in the unlicensed band according to one or more embodiments of a first example of the present invention.

FIG. 5 is a diagram showing a downlink and uplink transmission in the unlicensed band according to one or more embodiments of a first example of the present invention.

FIG. 6 is a diagram showing a downlink and uplink transmission in the unlicensed band according to one or more embodiments of a modified first example of the present invention.

FIG. 7 is a diagram showing a downlink and uplink transmission in the unlicensed band according to one or more embodiments of the modified first example of the present invention.

FIG. 8 is a diagram showing a downlink and uplink transmission in the unlicensed band according to one or more embodiments of the modified first example of the present invention.

FIG. 9 is a diagram showing a downlink and uplink transmission in the unlicensed band according to one or more embodiments of the modified first example of the present invention.

FIG. 10 is a diagram showing a downlink and uplink transmission in the unlicensed band according to one or more embodiments of the modified first example of the present invention.

FIG. 11 is a diagram showing a downlink and uplink transmission in the unlicensed band according to one or more embodiments of the modified first example of the present invention.

FIG. 12A is a sequence diagram showing an operation of performing LBT based on LBT-related information according to one or more embodiments of the modified first example of the present invention.

FIG. 12B is a sequence diagram showing an operation of performing LBT based on LBT-related information according to one or more embodiments of the modified first example of the present invention.

FIG. 13 is a diagram showing a downlink and uplink transmission in the unlicensed band according to one or more embodiments of a second example of the present invention.

FIG. 14 is a diagram showing OFDM symbols that multiplexes the CSI-RS in a resource block for a normal cyclic prefix and an extended cyclic prefix according to one or more embodiments of the present invention.

FIG. 15 is a diagram showing a downlink and uplink transmission in the unlicensed band according to one or more embodiments of a modified second example of the present invention.

FIG. 16 is a diagram showing a downlink and uplink transmission in the unlicensed band according to one or more embodiments of a third example of the present invention.

FIG. 17 is a diagram showing a downlink and uplink transmission in the unlicensed band according to one or more embodiments of a modified third example of the present invention.

FIG. 18 is a diagram showing a downlink and uplink transmission in the unlicensed band according to one or more embodiments of the modified third example of the present invention.

FIG. 19 is a sequence diagram showing a downlink and uplink transmission in the unlicensed band according to one or more embodiments of a fourth example of the present invention.

FIG. 20 is a diagram showing a downlink and uplink transmission in the unlicensed band according to one or more embodiments of the fourth example of the present invention.

FIG. 21A is a diagram showing a downlink and uplink transmission in the unlicensed band according to one or more embodiments of a fifth example of the present invention.

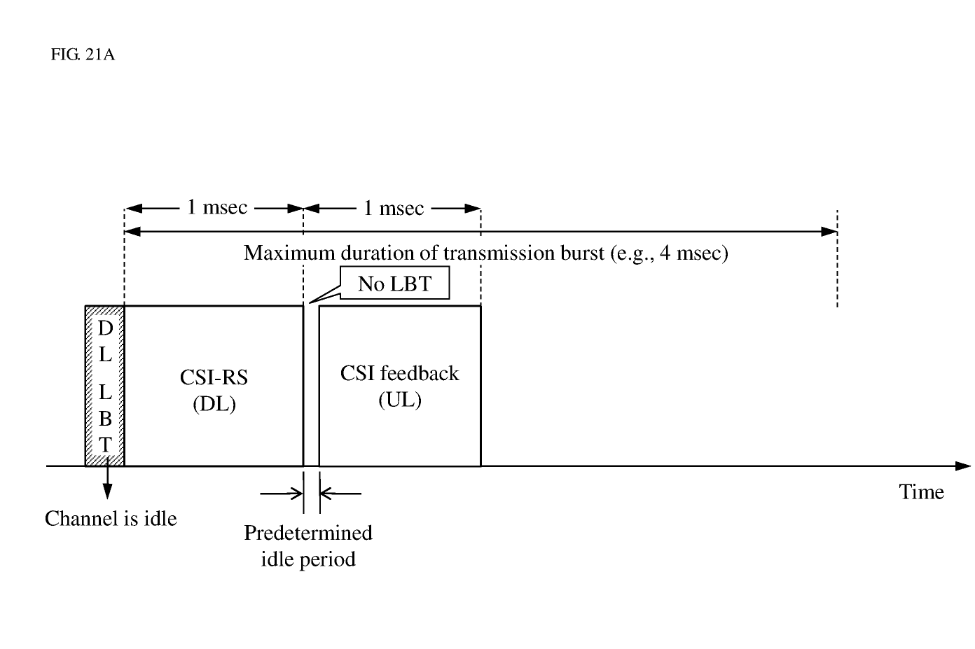

FIG. 21B is a diagram showing a downlink and uplink transmission in the unlicensed band according to one or more embodiments of the fifth example of the present invention.

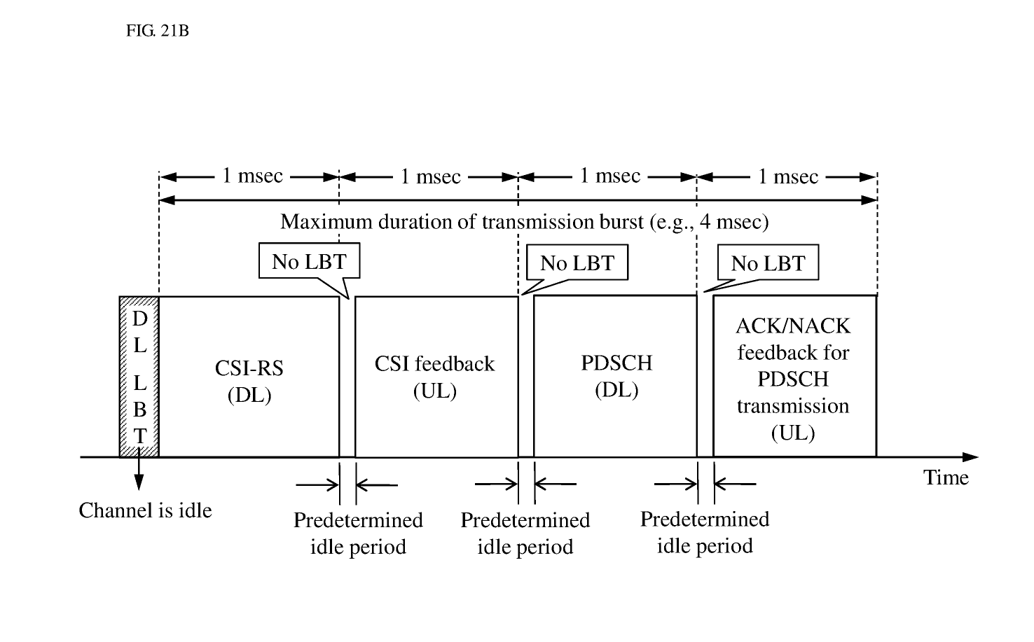

FIG. 21C is the diagram showing a downlink and uplink transmission in the unlicensed band according to one or more embodiments of the fifth example of the present invention.

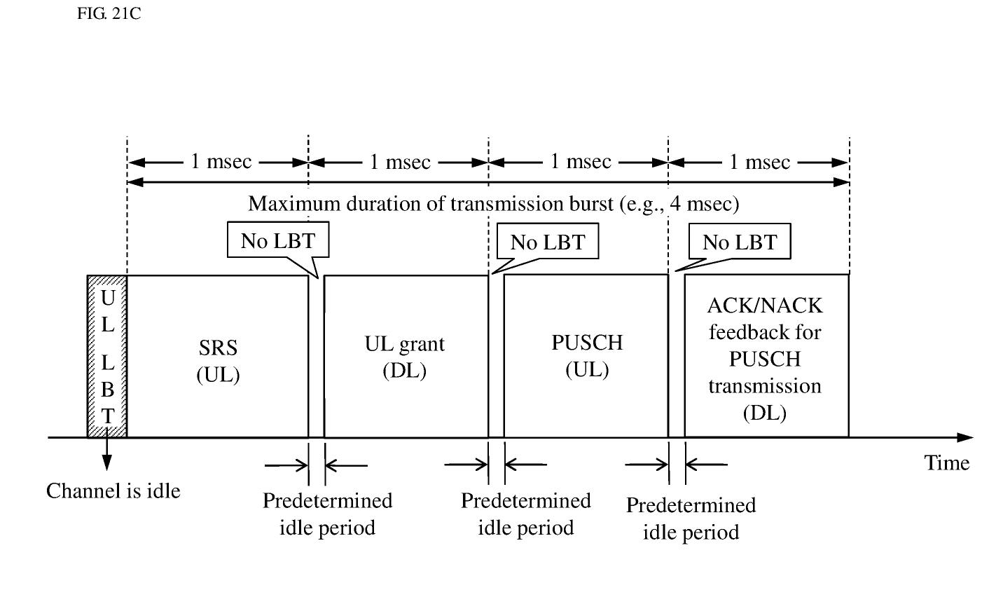

FIG. 22 is a block diagram showing a schematic configuration of the base station according to one or more embodiments of the present invention.

FIG. 23 is a block diagram showing a detailed configuration of the base station according to one or more embodiments of the present invention.

FIG. 24 is a block diagram showing a schematic configuration of the user equipment according to one or more embodiments of the present invention.

FIG. 25 is a block diagram showing a detailed configuration of the user equipment according to one or more embodiments of the present invention.

### DETAILED DESCRIPTION OF EMBODIMENTS

Embodiments of the present invention will be described in detail below, with reference to the drawings. In embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid obscuring the invention.

### (System Configuration)

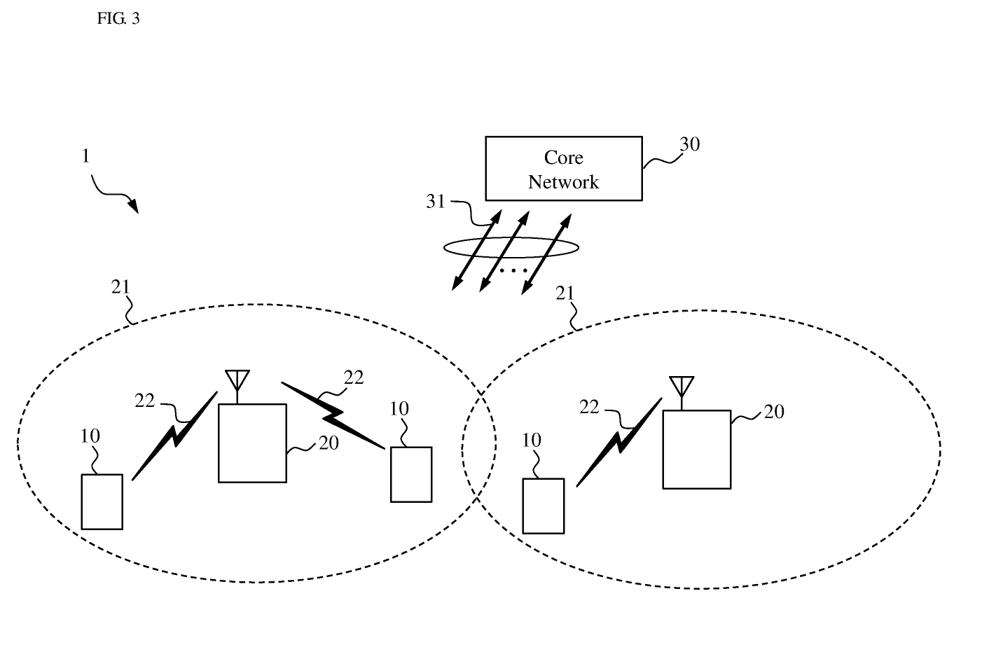

FIG. 3 illustrates a wireless communications system 1 according to one or more embodiments of the present invention. The wireless communication system 1 includes User Equipments (UEs) 10 (first/second transceiver), Base Stations (BSs) (or cells) 20 (first/second transceiver), and a core network 30. The wireless communication system 1 may be an LTE/LTE-Advanced (LTE-A) system using a Licensed Assisted Access (LAA) technology that supports transmission in unlicensed bands. The wireless communication system 1 is not limited to the specific configurations described herein and may be any type of wireless communication system using the unlicensed bands for transmission.

The wireless communication system 1 may require performing a Listen-Before-Talk (LBT) (Clear Channel Assessment (CCA)) before transmitting signals using a channel in the unlicensed band. When the channel in the unlicensed band is determined to be occupied (busy) by performing the LBT, signals are not transmitted using the channel in the unlicensed band. When the channel in the unlicensed band is determined not to be occupied (idle) by performing the LBT, signals are transmitted using the channel in the unlicensed band.

Using one or more antennas, the BS 20 may communicate uplink (UL) and downlink (DL) signals with the UEs 10 in a coverage area 21 using at least the unlicensed bands. The DL and UL signals include control information and user data. The BS 20 may communicate DL and UL signals with the core network 30 through backhaul links 31. The BS 20 may be Evolved NodeB (eNB). The BS 20 may provide the coverage area 21 for a macro cell and/or small cells such as pico cells and femto cells.

The BS 20 includes one or more antennas, a communication interface to communicate with an adjacent BS 20 (for example, X2 interface), a communication interface to communicate with the core network 30 (for example, S1 interface), and a CPU (Central Processing Unit) such as a processor or a circuit to process transmitted and received signals with the UE 10. Operations of the BS 20 described below may be implemented by the processor processing or executing data and programs stored in a memory. However, the BS 20 is not limited to the hardware configuration set forth above and may be realized by other appropriate hardware configurations as understood by those of ordinary skill in the art. Generally, a number of the BSs 20 are disposed so as to cover a broader service area of the wireless communication system 1.

Using one or multiple UE antennas, the UE 10 communicates DL and UL signals that include control information and user data with the base station 20 using at least the unlicensed bands. The UE 10 may be a mobile station, a smartphone, a cellular phone, a tablet, a mobile router, or information processing apparatus having a radio communication function such as a wearable device.

The UE 10 includes a CPU such as a processor, a RAM (Random Access Memory), a flash memory, and a radio communication device to transmit/receive radio signals to/from the BS 20 and the UE 10. For example, operations of the UE 10 described below may be implemented by the CPU processing or executing data and programs stored in a memory. However, the UE 10 is not limited to the hardware configuration set forth above and may be configured with, e.g., a circuit to achieve the processing described below.

Radio links 22 may include UL and DL transmission between the BS 20 and the UE 10. The DL and UL transmission may be made using both licensed bands and an unlicensed spectrum, or the unlicensed bands.

### First Example

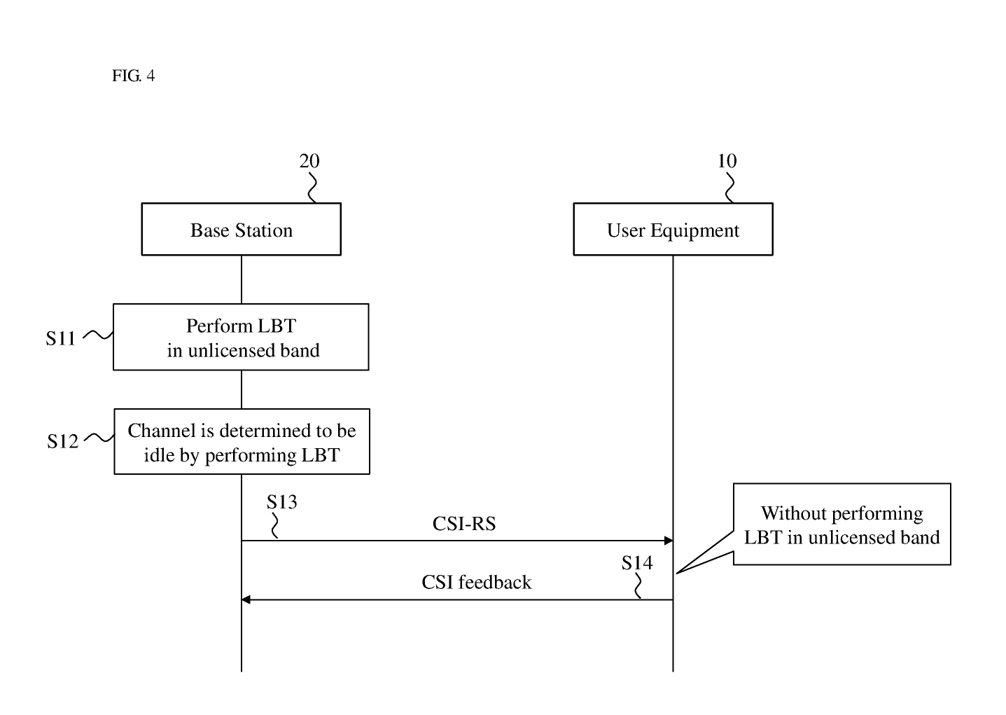

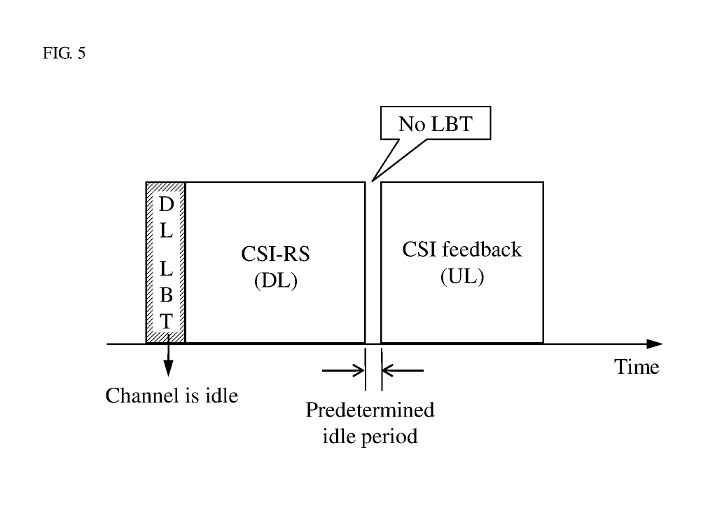

A method of the DL and UL transmission between the BS 20 and the UE 10 in unlicensed bands according to one or more embodiments of a first example of the present invention will be described below using FIGS. 4 and 5.

FIG. 4 is a sequence diagram illustrating DL and UL transmission in the unlicensed band according to one or more embodiments of a first example of the present invention. FIG. 5 shows DL/UL transmission between the BS 20 and the UE 10 in the unlicensed band according to one or more embodiments of a first example of the present invention.

As shown in FIG. 4, the BS 20 performs the LBT for the DL channel in the unlicensed band (DL LBT) before the BS 20 transmits the DL signal such as a Channel State Information Reference Signal (CSI-RS) or a Discovery Reference Signal (DRS) (step S11). The BS 20 may detect that the DL channel in the unlicensed band is idle by the BS 20 performing the LBT (step S12). If the DL channel in the unlicensed band is determined to be busy by performing the LBT, the BS 20 may wait before performing the LBT at next time. When the DL channel is determined to be idle by performing the DL LBT (after the BS 20 has performed the LBT), the BS 20 transmits the CSI-RS or the DRS to the UE 10 in the unlicensed band (step S13).

After the UE 10 receives the CSI-RS from the BS 20 in the unlicensed band, the UE 10 transmits the UL signal such as CSI feedback in response to the CSI-RS to the BS 20 in the unlicensed band without the UE 10 performing the LBT in the unlicensed band (step S14). Thus, according to one or more embodiments of the first example, after the BS 20 has transmitted the CSI-RS, the UE 10 transmits the UL signals to the BS 20 in the unlicensed band without the UE 10 performing the LBT for the UL channel in the unlicensed band (UL LBT). The method in the wireless communication system 1 according to one or more embodiments of the first example can prevent increasing the number of the LBT for the transmission in the unlicensed band and decreasing opportunities for the transmission in the unlicensed band. As a result, effectiveness of the DL and UL transmission in the unlicensed band in the LAA system can be improved.

According to one or more embodiments of the first example of the present invention, the BS 20 (first transceiver) may perform the Listen-Before-Talk (LBT) in the unlicensed band. After the BS 20 has performed the LBT, the BS 20 may transmit the CSI-RS (first signal) to the UE 10 (second transceiver) in the unlicensed band. After the BS 20 has transmitted the CSI-RS, the UE 10 may transmit the CSI feedback information (second signal) to the BS 20 in the unlicensed band without the UE 10 performing the LBT. Thus, when the first signal is the DL signal and the second signal is the UL signal, the first transceiver may be the BS 20 and the second transceiver may be the UE 10. On the other hand, when the first signal is the UL signal and the second signal is the DL signal, the first transceiver may be the UE 10 and the second transceiver may be the BS 20.

As shown in FIG. 5, the UE 10 may stand by for a lapse of a predetermined idle or a random idle period before the UE 10 transmits the UL signal (CSI feedback). That is, the UE 10 may transmit the UL signal (CSI feedback) after the predetermined idle or the random idle period from when UE 10 receives the DL signal (CSI-RS). For example, the predetermined idle period may be equal to the amount of time granted by Short Inter Frame Space (SIFS) depending on an IEEE 802.11 standard so as to support friendly co-existence with Wi-Fi. For example, the SIFS defined in IEEE 802.11b/g/n (2.4 GHz) is 10 μsec and the SIFS defined in IEEE 802.11a/n (5 GHz)/ac is 16 μsec. The predetermined idle period may be zero seconds. For example, the predetermined idle period may be calculated based on timing advance information. Uplink transmission timing control such as LTE-A may be performed and an additional predetermined idle period may be set. The predetermined idle period may be randomly determined. The predetermined idle period may be semi-statically or dynamically set so that transmission timing for a feedback signal such as the CSI feedback or acknowledgement/negative acknowledgement (ACK/NACK) feedback can be flexibly arranged. As described above, in one or more embodiments of the first example, the CSI-RS is an example of a first signal and the CSI feedback is an example of a second signal transmitted in response to the first signal. However, in one or more embodiments of the first example, the second signal in response to the first signal may be other cases such as an UL data signal on a physical uplink shared channel (PUSCH) in response to a UL grant, UL ACK/NACK feedback in response to DL data in response to a physical downlink shared channel (PDSCH), the UL grant in response to a scheduling request, or signals in a random access procedure.

### Modified First Example

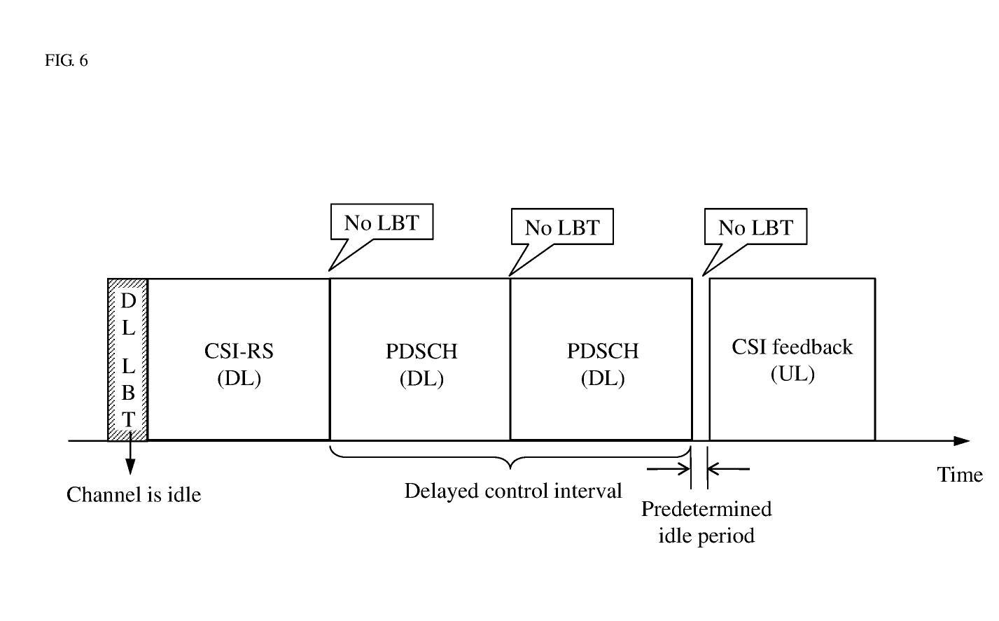

FIG. 6 illustrates a DL and UL transmission in the unlicensed band according to one or more embodiments of a modified first example. Generating the feedback signal such as the CSI feedback based on the received signal such as the CSI-RS in the UE 10 may cause delayed control in the UE 10. In one or more embodiments of the modified first example, the BS 20 may transmit at least one of DL data signals and UL data signals to be used for keeping resources during delayed control intervals for generating the CSI feedback based on the CSI-RS without the BS 20 performing the LBT. As shown in FIG. 6, for example, the DL data signals to be used for keeping resources may be the PDSCH. The UE 10 may generate the CSI feedback on the received CSI-RS during the delayed control intervals and transmit the generated CSI feedback without performing the LBT. In embodiments of the first example, the CSI-RS may be included in around a head of a transmission burst as shown in FIG. 6. In one or more embodiments of the present invention, the transmission burst may be a continuous transmission that includes signals to be transmitted sequentially. That is, when the UE 10 receives at least one DL data signal from the BS 20 after the UE 10 receives the CSI-RS, the UE 10 may transmit the CSI feedback information after a predetermined idle period from when the UE receives a last DL data signal of the at least one DL data signal.

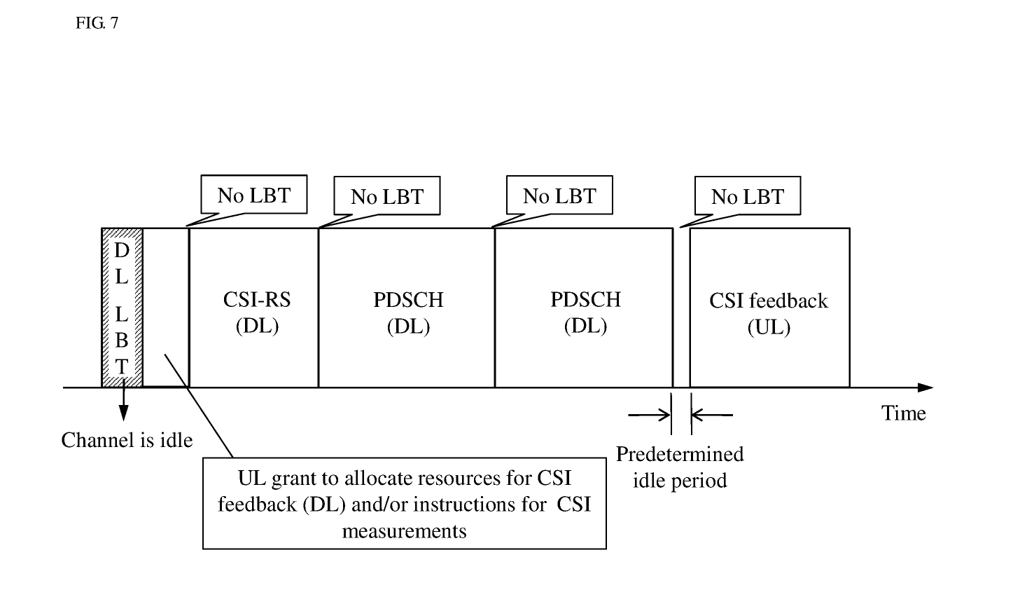

According to one or more embodiments of the modified first example, as shown in FIG. 7, the BS 20 may transmit an UL grant to allocate resources for the CSI feedback using downlink control information (DCI) on a control channel (e.g., physical downlink control channel (PDCCH)/enhanced PDCCH (EPDCCH)) in the transmission burst in which the UE 10 may transmit the CSI feedback. The UL grant may be included around a head of the transmission burst as shown in FIG. 7. A plurality of CSI feedback for a plurality of UEs 10 may be multiplexed in the same TTI. In addition, the BS 20 may transmit information on an instruction of a CSI measurement in the transmission burst. The information on the instruction of the CSI measurement may be included in around a head of the transmission burst. The information on the instruction of the CSI measurement may include information that indicates a subframe location of CSI-RS and/or cell-specific reference signals (CRS). In this case, a part of a CSI-RS configuration such as a cycle and subframe offset may be omitted (because the cycle and the subframe offset is dynamically notified by the BS 20 to the UE 10. Furthermore, as shown in FIG. 7, the BS 20 may transmit signals (CSI-RS and a plurality of DL data signals on the PDSCH) without the BS 20 performing the LBT.

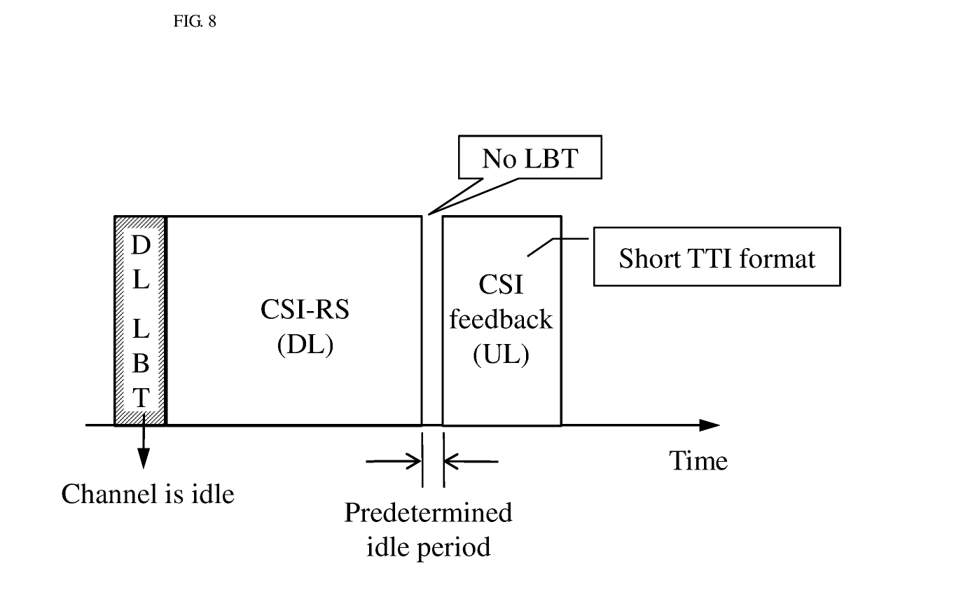

According to one or more embodiments of the modified first example, as shown in FIG. 8, the UE 10 may transmit feedback signals (e.g., CSI feedback and ACK/NACK feedback) with a short TTI format without the LBT. A Short TTI is less than 1 TTI (1 ms). In one or more embodiments of the modified first example, the short TTI format for the UL transmission may be a newly defined Physical Uplink Control Channel (PUCCH) format. All frequency resources during the short TTI may be used as feedback transmission with the TTI format such as the newly defined PUCCH format, and an UL data signal may not be multiplexed. The short TTI format may be a PUCCH format without frequency hopping, of which the size is 1 slot (0.5 msec). The short TTI format may use a newly defined symbol mapping corresponding to the number of an uplink pilot time slot (UpPTS). A configuration of the newly defined symbol mapping may be “1 symbol and feedback data” and “1 symbol” for a demodulation reference signal (DMRS). The short TTI mechanism can be also applied for downlink signals. For example, one implementation can use a downlink pilot time slot (DwPTS).

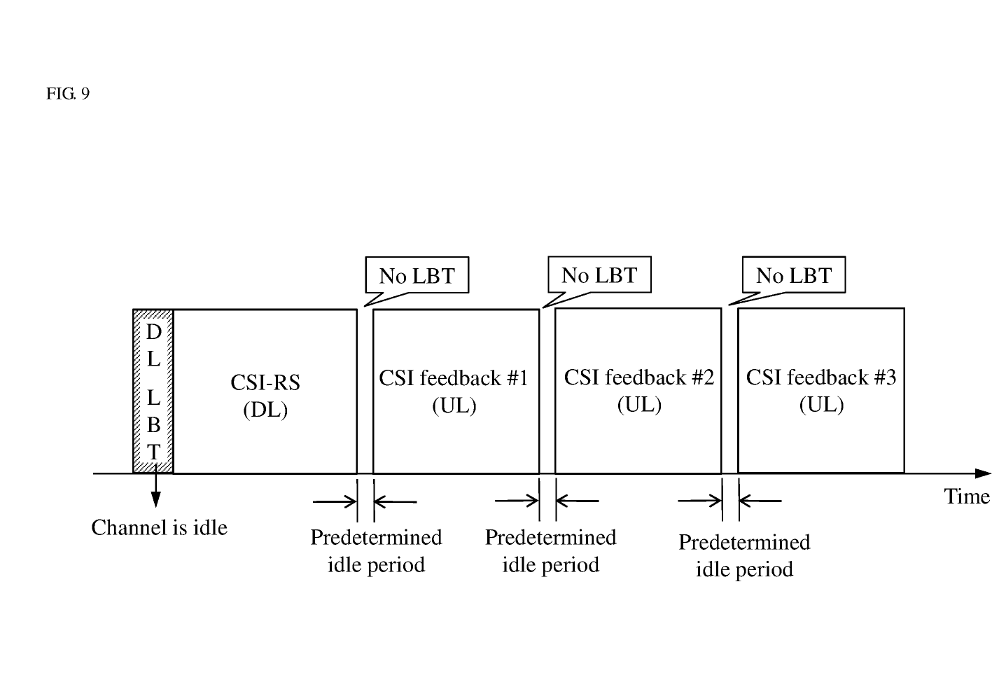

According to one or more embodiments of the modified first example, as shown in FIG. 9, when a plurality of UEs 10 receives the CSI-RS in the unlicensed band from the BS 20, the plurality of UEs 10 may transmit the CSI feedback. Thus, a plurality of CSI feedback may be time-multiplexed. As shown in FIG. 9, for example, when the UEs 10#1-3 receives the CSI-RS in the unlicensed band, the UE 10#1 transmits the CSI feedback #1 in the unlicensed band without the UE 10#1 performing the LBT. After the CSI feedback #1 has been transmitted, the UE 10#2 transmits the CSI feedback #2 in the unlicensed band without the UE 10#2 performing the LBT. After the CSI feedback #2 has been transmitted, the UE 10#3 transmits the CSI feedback #3 in the unlicensed band without the UE 10#3 performing the LBT. The modified first example as shown in FIG. 9 is not limited to a case where a plurality of UEs 10 respectively transmits the CSI feedback, and may be applied to a case where single UE 10 transmits a plurality of CSI feedback (e.g., CSI feedback #1-3).

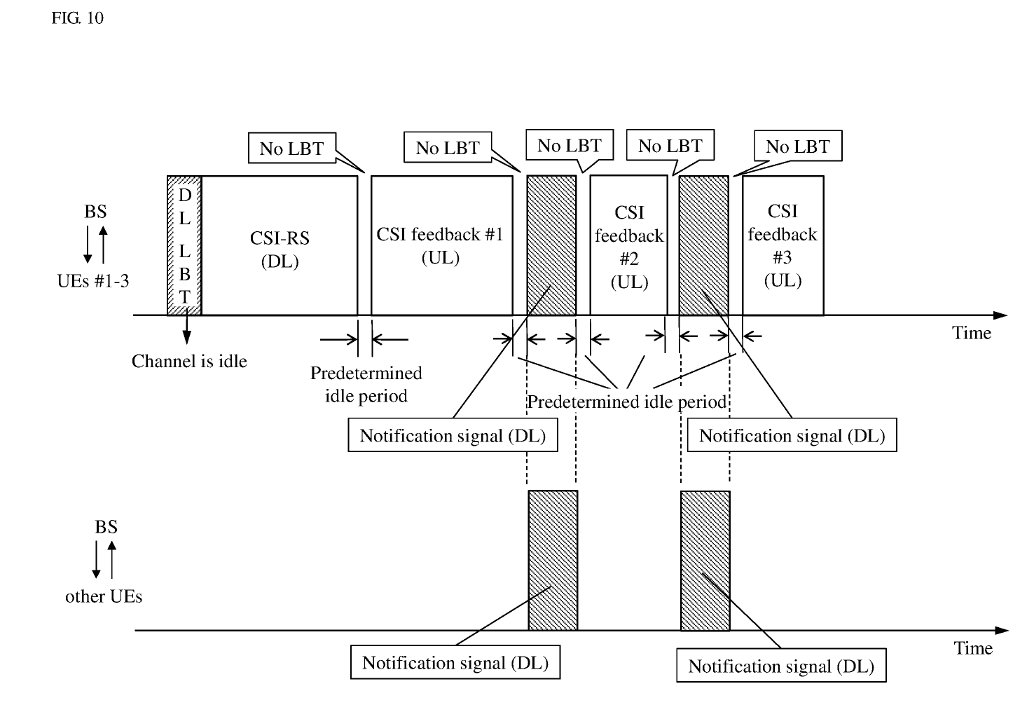

On the other hand, for example, when a plurality of UEs 10 cannot detect each other by carrier sensing because they are separated by obstructions such as walls or buildings, one of the UEs 10 starts transmission of a signal, which causes interference and collisions of their signals (a phenomenon known as a hidden terminal problem). To avoid the hidden terminal problem, as shown in FIG. 10, the BS 20 may transmit notification signals to other UEs 10 in addition to the UEs #1-3 during each of intervals between the CSI feedback transmissions from the UEs 10. The notification signals may be used to cause other UEs 10 to keep quiet (to not transmit signals). This makes it possible to avoid the hidden terminal problem.

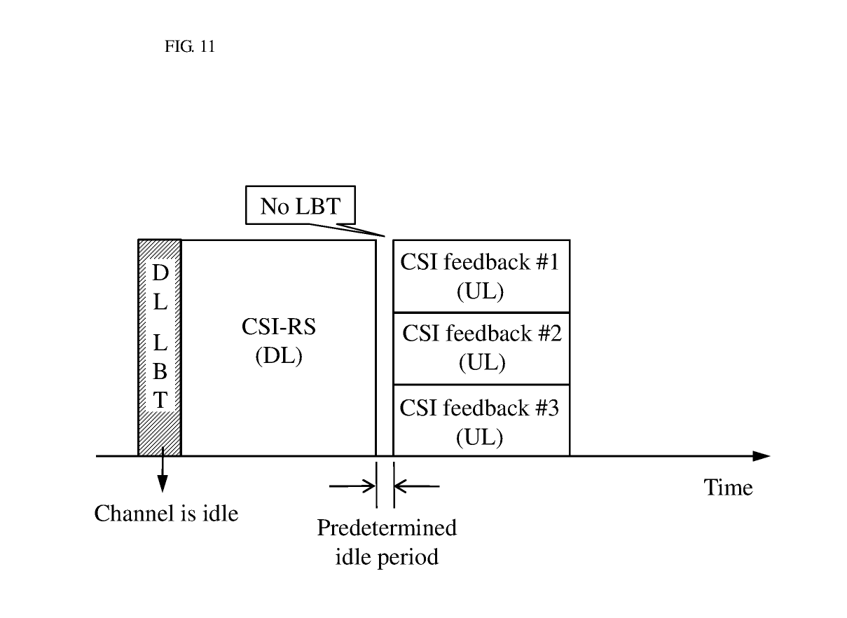

On the other hand, time-multiplexing a plurality of CSI feedback transmitted by a plurality of UEs 10 only may cause excessive exhaustion of time resources. According to one or more embodiments of the modified first example, as shown in FIG. 11, a plurality of CSI feedback transmitted by a plurality of UEs 10 may be frequency-multiplexed, code-multiplexed, or time-multiplexed in a single time slot or a single subframe.

Although, in the above embodiments of the first example, both of the downlink signal (e.g., CSI-RS) and the uplink signal (e.g., CSI feedback) are transmitted in the transmission burst, the CSI-RS and the CSI feedback may each be transmitted in the different transmission bursts. For example, the CSI-RS and the CSI feedback may be transmitted in a first transmission burst and a second transmission burst, respectively. In this case, the CSI feedback may be multiplexed in an end portion in the second transmission burst without performing the LBT.

Although the CSI-RS in the above embodiments of the first example is a CSI-RS that is transmitted to the UE 10 itself, the first example may also be applied to a CSI-RS, which is transmitted from a serving eNB but to other UEs. That is, when the BS 20 transmits any CSI-RS to the cell of the BS 20, a predetermined interval in which the LBT is not required may be provided to the UE 10 that connects to the cell. For example, the UE 10 may specify a cell ID of a Cell-specific Reference Signal (CRS) based on location information (quasi-colocation information) corresponding to the CSI-RS.

Furthermore, the first example is not limited to application of the CSI-RS. For example, when the BS 20 transmits DL signals to the cell of the BS 20, a predetermined interval in which the LBT is not required may be provide to the UEs 10 that connects to the cell.

Furthermore, because a part of DL signals (e.g., UE-specific CSI-RS) is UE-specifically allocated to resources to the cell of the BS 20, the UE 10 may not specify which cell transmits a part of the DL signals (e.g., UE-specific CSI-RS), namely, a Physical Cell Identity (PCID). Therefore, for example, the BS 20 may notify the UE 10 of a relationship between the CSI-RS and the PCID when the CSI-RS is configured. In addition, the UE 10 may not perform the LBT before the UE 10 transmits UL signals to the cell corresponding to the PCID notified by the BS 20.

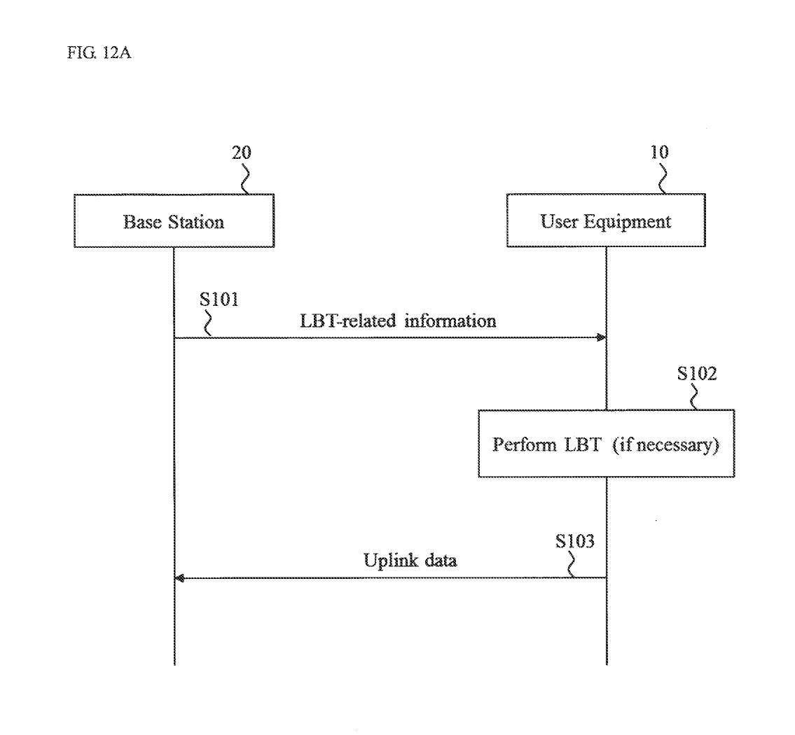

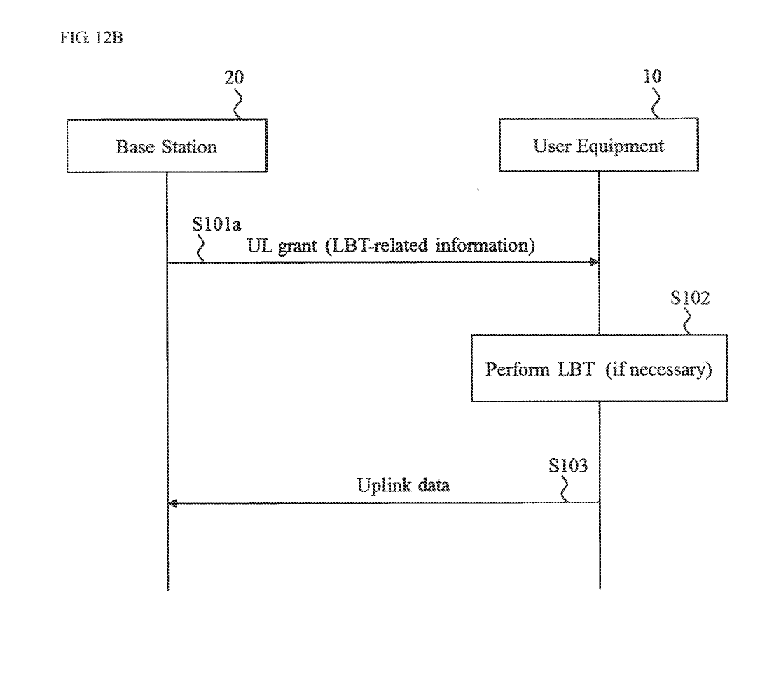

According to one or more embodiments of the modified first example, as shown in FIG. 12A, the BS 20 may signal LBT-related information to the UE 10 using a Radio Resource Control (RRC) signaling, Medium Access Control (MAC) Control Element (CE), and/or the DCI (step S101). The LBT-related information may indicate whether or not the UE 10 performs the LBT. The UE 10 may determine to perform the LBT based on the LBT-related information, and then, the UE 10 may perform the LBT if necessary (step S102). The UE 10 may transmit uplink data to the BS 20 (step S103).

For example, the LBT-related information may include LBT parameters indicating timing for performing LBT, a random backoff value and/or a Distributed Inter-frame Space (DIFS) value.

As another example, as shown in FIG. 12B, the BS 20 may transmit the UL grant including the LBT-related information (step S101a). Operations at the steps S102 and S103 in FIGS. 12A and 12B are similar.

### Second Example

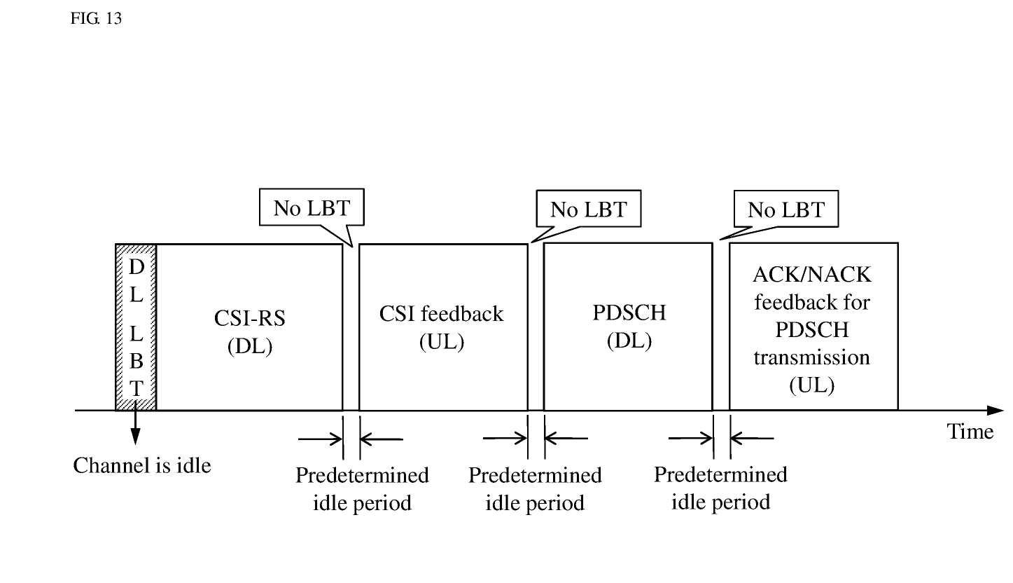

In a DL precoding transmission in a multiple-input multiple-output (MIMO) system, the CSI-RS, the CSI feedback in response to the CSI-RS, the PDSCH based on the CSI feedback, and ACK/NACK feedback for the PDSCH transmission are transmitted between the BS 20 and the UE 10. According to one or more embodiments of a second example of the present invention, the single LBT before the transmission burst may be performed for all or part of the transmission (CSI-RS, CSI feedback, PDSCH, and ACK/NACK feedback for the PDSCH transmission) in the transmission burst. Embodiments of the second example of the present invention will be described in detail with reference to FIG. 13. In one or more embodiments of the second example, the BS 20 and the UE 10 transmit and receive signals between each other using MIMO technology.

In one or more embodiments of the second example, the BS 20 performs the DL LBT before the BS 20 transmits the CSI-RS. When the DL channel is determined to be idle by performing the DL LBT, the BS 20 transmits the CSI-RS to the UE 10 in the unlicensed band.

The UE 10 receives the CSI-RS from the BS 20 in the unlicensed band. Then, the UE 10 transmits the CSI feedback in response to the CSI-RS to the BS 20 in the unlicensed band without the UE 10 performing the UL LBT. Thus, the UE 10 does not perform the UL LBT before the UE 10 transmits the CSI feedback in the unlicensed band.

The BS 20 receives the CSI feedback from the UE 10 in the unlicensed band. Then, the BS 20 transmits the DL data signal (PDSCH) based on the received CSI feedback to the UE 10 in the unlicensed band without the BS 20 performing the DL LBT. Thus, the BS 20 does not perform the DL LBT before the BS 20 transmits the PDSCH in the unlicensed band.

The UE 10 receives the PDSCH from the BS 20 in the unlicensed band. Then, the UE 10 transmits the ACK/NACK feedback for the PDSCH transmission to the BS 20 in the unlicensed band without the UE 10 performing the UL LBT. Thus, the UE 10 does not perform the UL LBT before the UE 10 transmits the ACK/NACK feedback for the PDSCH transmission in the unlicensed band.

The BS 20 may transmit the DL signal (e.g., PDSCH) in the unlicensed band after a predetermined idle period (e.g., SIFS) when the BS 20 receives the UL signal (e.g., CSI feedback) from the UE 10. The UE 10 may transmit the UL signal (e.g., CSI feedback and AKC/NACK feedback for the PDSCH transmission) in the unlicensed band after a predetermined idle period when the UE 10 receives the DL signal (e.g., CSI-RS and PDSCH). As described above, the predetermined idle period may be zero seconds or randomly determined.

Although in the second example, as shown in FIG. 13, the BS 20 and the UE 10 do not perform the LBT before all of the transmission (CSI feedback, PDSCH, and ACK/NACK feedback transmission), the BS 20 and the UE 10 may not perform the LBT before just one or some of the transmission.

Thus, the method of the transmission in the unlicensed band according to one or more embodiments of the second example of the present invention may be capable of improving efficiency of the closed-loop DL precoding transmission because the single LBT before the transmission burst is performed for all or part of the transmission (CSI-RS, CSI feedback, PDSCH, and ACK/NACK feedback for the PDSCH transmission) in the transmission burst.

### Modified Second Example

The TTI for each signal to which conventional subframe configurations defined in a LTE standard are applied is 1 msec (TTI). Therefore, for example, the TTI for the signals in the DL precoding transmission in the MIMO system (CSI-RS, CSI feedback, PDSCH, and ACK/NACK feedback for the PDSCH transmission) may be 4 msec (TTI). As a result, more time resources may be used for the signals (CSI-RS, CSI feedback, PDSCH, and ACK/NACK feedback for the PDSCH transmission).

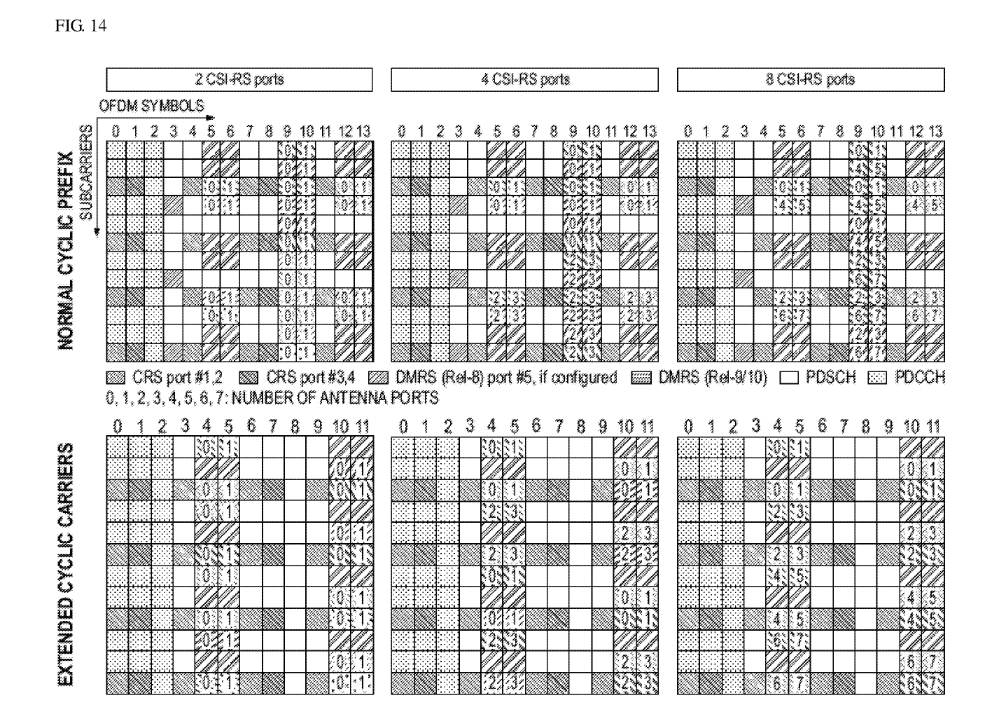

On the other hand, FIG. 14 shows OFDM symbols that multiplexes the CSI-RS in a resource block (RB) for a normal cyclic prefix and an extended cyclic prefix according to one or more embodiments of the present invention. As shown in FIG. 14, one axis designates OFDM symbols and the other axis designates subcarriers, and resource elements (REs) are allocated to the CSI-RS antenna ports. Each block corresponds to the RE in the RB and the hatched REs with the number of antenna ports are allocated to the CSI-RS antenna ports. Furthermore, as shown in FIG. 14, two REs are allocated to the CSI-RS antenna ports when the BS 20 designates two CSI-RS antenna ports. Moreover, four REs are allocated to the CSI-RS antenna ports when the BS 20 designates four CSI-RS antenna ports, and eight REs are allocated to the CSI-RS antenna ports when the BS 20 designates eight CSI-RS antenna ports.

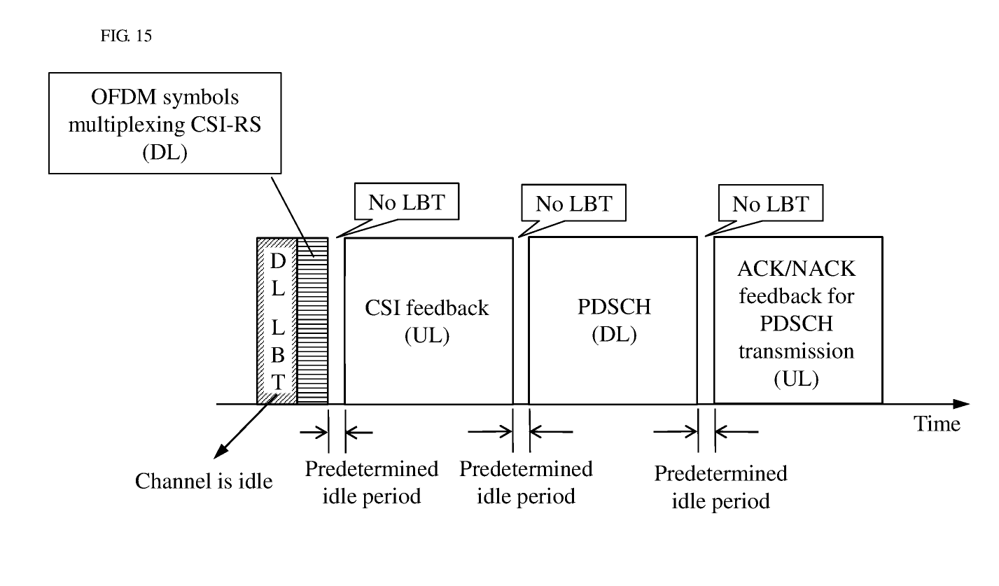

According to one or more embodiments of the modified second example, the TTI for the signals in the DL precoding transmission in the MIMO system may be shortened. FIG. 15 illustrates a DL and UL transmission in the unlicensed band according to one or more embodiments of a modified second example. As shown in FIG. 15, the BS 20 may transmit only OFDM symbols that multiplex the CSI-RS in the unlicensed band. That is, the transmitting of the CSI-RS is performed as only the OFDM symbols that includes the CSI-RS. For example, referring to FIG. 14, the BS may transmit only the OFDM symbols that multiplex the CSI-RS of fourteen OFDM symbols. Thus, in one or more embodiments of the second modified example, the TTI that is required for the CSI-RS transmission may be shortened (less than 1 msec (TTI)). As a result, the method according to one or more embodiments of the second modified example can efficiently utilize time resources in the transmission in the unlicensed band. One possible implementation may use the DwPTS. As another implementation, the BS 20 or the UE 10 may transmit some signals in order to avoid the channel used by other systems. The signal can be transmitted until CSI-RS symbols start.

In one or more embodiments of the second modified example as shown in FIG. 15, the BS 20 transmits the OFDM symbols that multiplex the CSI-RS in the unlicensed band after the BS 20 performs the DL LBT. Then, once the UE 10 receives the OFDM symbols that multiplex the CSI-RS, the UE 10 transmits the CSI feedback in the unlicensed band after the predetermined period (e.g., SIFS or zero seconds). That is, a switch between DL and UL occurs once the UE 10 receives the OFDM symbols that multiplex the CSI-RS. As another example, a guard time may be provided at the time of the switch between DL and UL. As another example, the BS 20 may transmit DL signals to be used for keeping resources after the transmission of the OFDM symbols that multiplex the CSI-RS during the delayed control intervals for generating the CSI feedback based on the CSI-RS.

In one or more embodiments of the second modified example, although each CSI-RS resource is configured to be UE-specific, the BS 20 may transmit the CSI-RS for other UEs 10 in the cell of the BS 20. As a result, the UE 10 may not determine timing for the CSI feedback transmission. Therefore, as another example, the BS 20 may notify the cell of the BS 20 of information that indicates the OFDM symbols multiplexes each CSI-RS. The information is not limited to being applicable for the CSI-RS transmission. For example, the information may be applicable for other downlink signals.

In one or more embodiments of the second modified example, when the BS 20 transmits only OFDM symbols that multiplex the CSI-RS in the unlicensed band, the total DL transmission power may decrease due to low density of the CSI-RS. As a result, the decrease of the total DL transmission power may cause a possibility of erroneous detection in the LBT performed by other systems because those systems cannot detect the decreased total DL transmission power. Therefore, resources for predetermined signals may be allocated to unused REs included in the OFDM symbols that multiplex the CSI-RS so as to prevent excessive decreases of the total DL transmission power. As another example, the CSI-RS may be transmitted with higher transmission power. This mechanism can be applied for other reference signals or physical channels other than the CSI-RS.

### Third Example

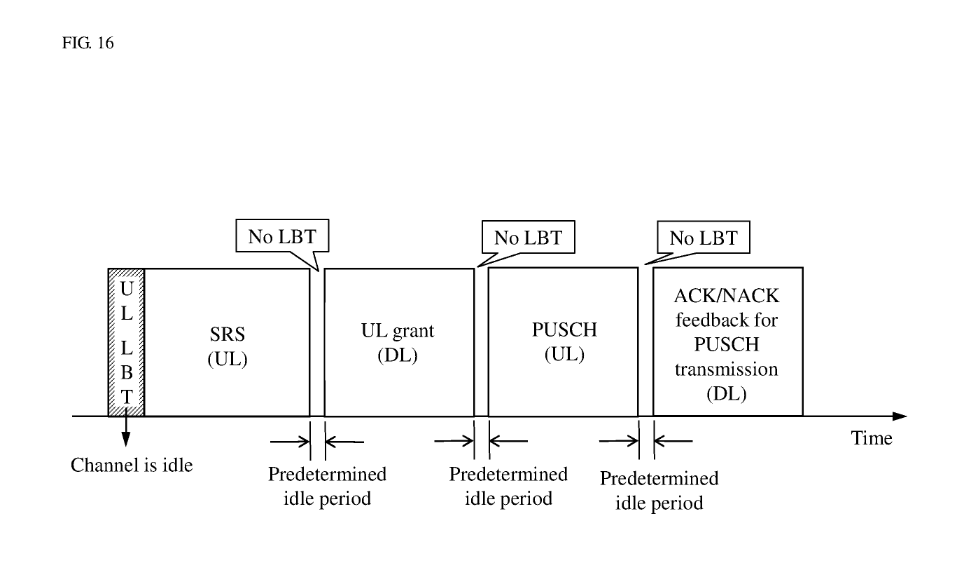

In UL precoding transmission in the MIMO system, a sounding reference signal (SRS), the UL grant, the PUSCH, and ACK/NACK feedback for the PUSCH transmission are transmitted between the BS 20 and the UE 10. According to one or more embodiments of a third example of the present invention, the single LBT before the transmission burst may be performed for all or part of the transmission (SRS, UL grant, PUSCH, and ACK/NACK feedback for the PUSCH transmission) in the transmission burst. Embodiments of the third example of the present invention will be described in detail with reference to FIG. 16. In one or more embodiments of the third example, the BS 20 and the UE 10 transmit and receive signals between each other using the MIMO technology.

In one or more embodiments of the third example, the UE 10 performs the UL LBT before the UE 10 transmits the SRS. When the UL channel is determined to be idle by performing the UL LBT, the UE 10 transmits the SRS to the UE 10 in the unlicensed band.

The BS 20 receives the SRS from the UE 10 in the unlicensed band. Then, the BS 20 transmits the UL grant in response to the SRS to the UE 10 in the unlicensed band without the BS 20 performing the DL LBT. Thus, the BS 20 does not perform the DL LBT before the BS 20 transmits the UL grant in the unlicensed band.

The UE 10 receives the UL grant from the BS 20 in the unlicensed band. Then, the UE 10 transmits the UL data signal on a PUSCH in response to the UL grant to the BS 20 in the unlicensed band without the UE 10 performing the UL LBT. Thus, the UE 10 does not perform the UL LBT before the UE 10 transmits the PUSCH in the unlicensed band.

The BS 20 receives the PUSCH from the UE 10 in the unlicensed band. Then, the BS 20 transmits the ACK/NACK feedback for the PUSCH transmission to the UE 10 in the unlicensed band. The BS 20 does not perform the UL LBT before the BS 20 transmits the ACK/NACK feedback for the PUSCH transmission in the unlicensed band.

The UE 10 may transmit the UL signal (e.g., PUSCH) in the unlicensed band after a predetermined idle period (e.g., SIFS) when the UE 10 receives the DL signal (e.g., UL grant) from the BS 20. The BS 20 may transmit the DL signal (e.g., UL grant and AKC/NACK feedback for the PUSCH transmission) in the unlicensed band after a predetermined idle period when the BS 20 receives the UL signal (e.g., SRS and PUSCH). As described above, the predetermined idle period may be zero seconds.

Although in the third example as shown in FIG. 16, the BS 20 and the UE 10 do not perform the LBT before all of the transmission (SRS, UL grant, PUSCH, and ACK/NACK feedback for the PUSCH transmission) in the unlicensed band, the BS 20 and the UE 10 may not perform the LBT before just one or some of the transmission in the unlicensed band.

Thus, the method of the transmission in the unlicensed band according to one or more embodiments of the third example of the present invention may be capable of improving efficiency of the closed-loop UL precoding transmission because the single LBT before the transmission burst is performed for all or part of the transmission (SRS, UL grant, PUSCH, and ACK/NACK feedback for the PUSCH transmission) in the transmission burst.

### Modified Third Example

As described above, the TTI for each signal to which conventional subframe configurations defined in the LTE standard are applied is 1 msec (TTI). Therefore, for example, the TTI for the signals in the UL precoding transmission in the MIMO system (SRS, UL grant, PUSCH, and ACK/NACK feedback for the PUSCH transmission) may be 4 msec (TTI). As a result, more time resources may be used for the signals (SRS, UL grant, PUSCH, and ACK/NACK feedback for the PUSCH transmission).

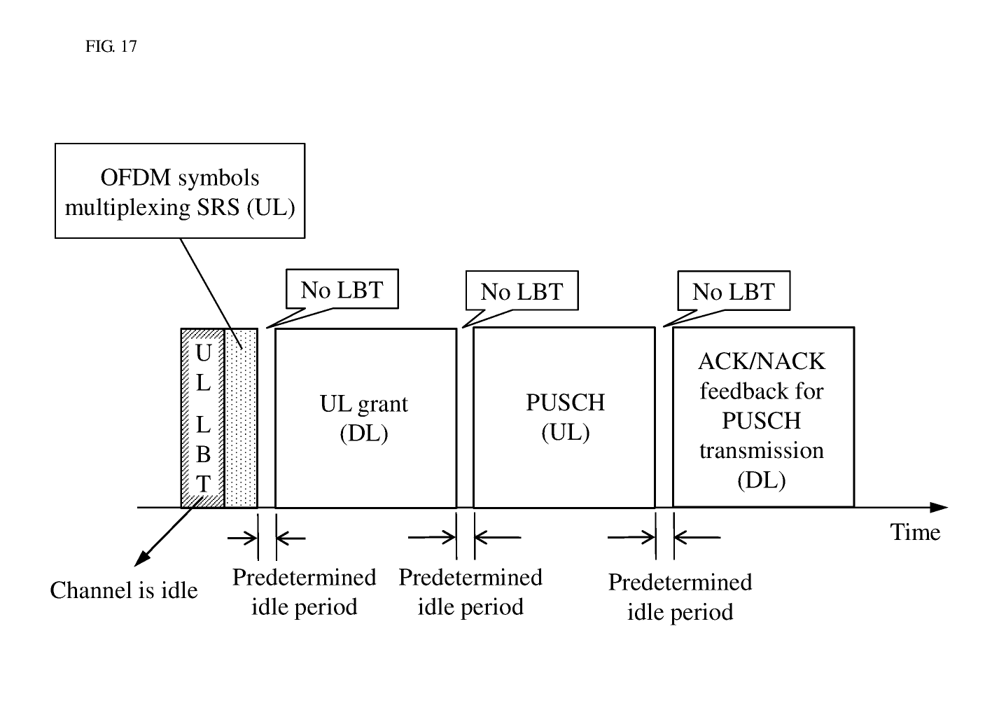

According to one or more embodiments of the modified third example, the TTI for the signals in the UL precoding transmission in the MIMO system may be shortened. FIG. 17 illustrates a DL and UL transmission in the unlicensed band according to one or more embodiments of a modified third example. As shown in FIG. 17, the UE 10 may transmit only OFDM symbols that multiplex the SRS in the unlicensed band. That is, the transmitting of the SRS is performed as only the OFDM symbols that includes the SRS. Thus, in one or more embodiments of the third modified example, the TTI that is required for the SRS transmission may be shortened (less than 1 msec (TTI)). As a result, the method according to one or more embodiments of the third modified example can efficiently utilize time resources in the transmission in the unlicensed band.

The LTE standard defines the OFDM symbol #13 that multiplexes the SRS. In one or more embodiments of the third modified example, the OFDM symbol other than the OFDM symbol #13 may multiplex the SRS. In this case, an initial signal to detect a timing may be set in front of the SRS in the OFDM symbol.

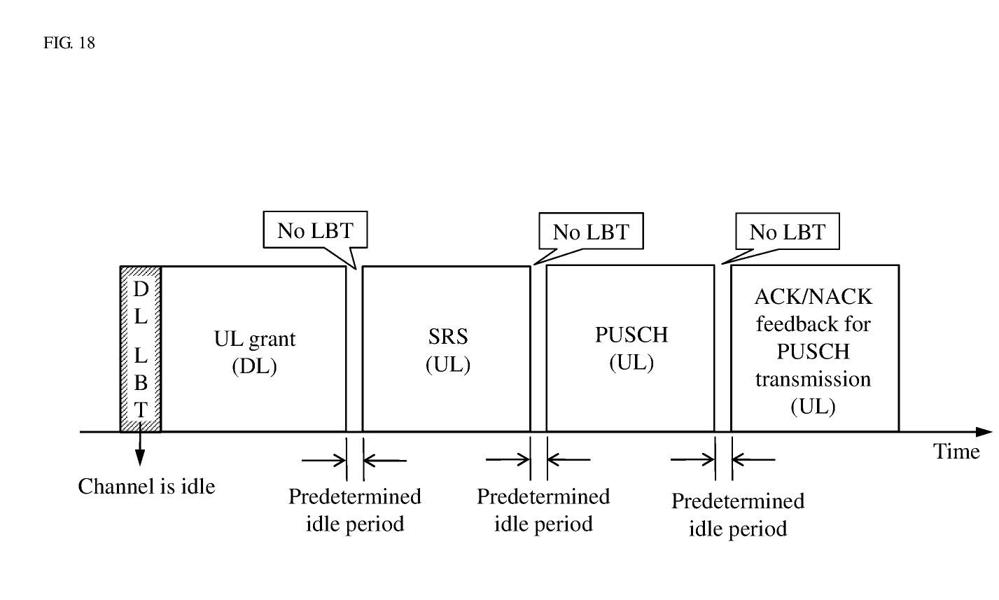

According to one or more embodiments of the modified third example, as shown in FIG. 18, the SRS transmission in the UL precoding transmission in the MIMO system may be triggered by the conventional UL grant. The conventional UL grant that triggers the SRS transmission may also trigger the PUSCH transmission.

According to one or more embodiments of the modified third example, the BS 20 may transmit only the OFDM symbols that multiplex the UL grant and the ACK/NACK feedback for the PUSCH transmission (physical HARQ indicator channel (PHICH)) in the UL precoding transmission in the MIMO system. In this case, the UE 10 may specify a final OFDM symbol in the PDCCH based on a physical control format indicator channel (PCFICH) and determine a timing to transmit continuous UL signals.

In one or more embodiments of the third modified example as shown in FIG. 18, the UE 10 transmits the OFDM symbols that multiplex the SRS in unlicensed band after the UE 10 performs the UL LBT. Then, once the BS 20 receives the OFDM symbols that multiplex the SRS, the BS 20 transmits the UL grant in the unlicensed band after the predetermined period (e.g., SIFS or zero seconds). That is, a switch between DL and UL occurs once the BS 20 receives the OFDM symbols that multiplex the SRS. As another example, a guard time may be provided at the time of the switch between UL and DL.

### Fourth Example

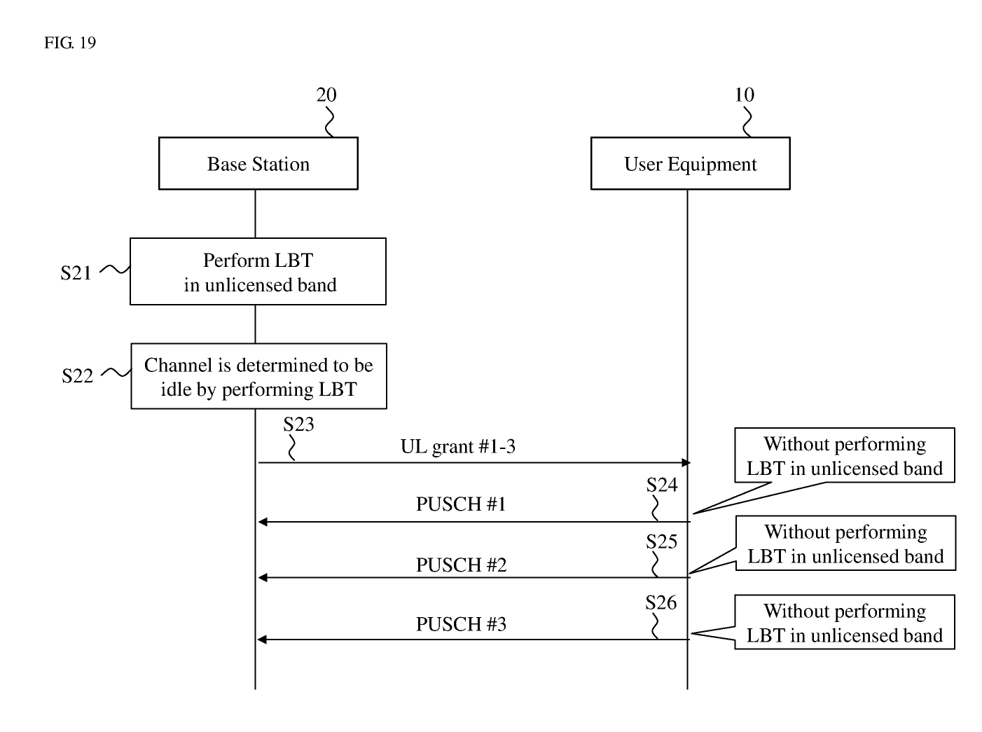

For example, in the UL transmission during 4 msec (TTI) in a legacy LTE system, the total number of the UL grant and the PUSCH transmission is eight times. In this case, the LBT may be required eight times for the UL transmission in the unlicensed band during 4 msec. Thus, when the channel in the unlicensed band is determined to be busy by performing the LBT, opportunities for the transmission may be lost and the number of performing the LBT may be increased. A method of the transmission in the unlicensed band according to embodiments of a fourth example will be described below, with reference to FIGS. 18 and 19.

FIG. 19 is a sequence diagram illustrating DL and UL transmission in the unlicensed band according to one or more embodiments of a fourth example of the present invention.

As shown in FIG. 19, the BS 20 may perform the DL LBT in the unlicensed band (step S21). The BS 20 may detect that the DL channel in the unlicensed band is idle by the BS 20 performing the LBT (step S22). If the DL channel in the unlicensed band is determined to be busy by performing the LBT, the BS 20 may wait before performing the LBT at next time.

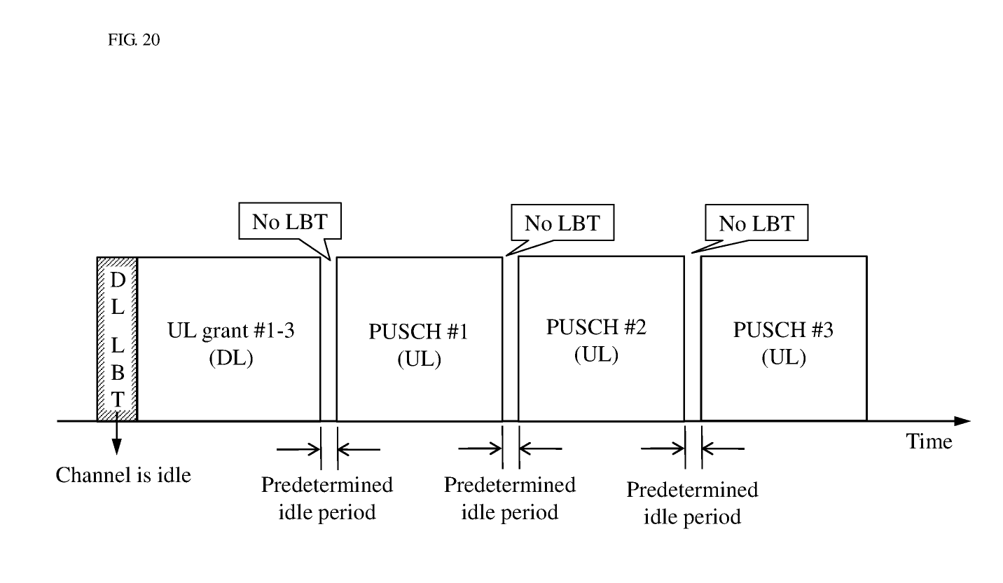

The BS 20 may transmit the UL grant (UL grant #1-3) in the unlicensed band to the UE 10 (step S23). As shown in FIG. 20, the UL grant #1-3 may be transmitted during a duration of the single UL grant transmission. The UL grant (UL grant #1-3) may be used for scheduling a plurality of continuous TTIs. Thus, it is possible to decrease the number of the UL grant because the BS 20 may transmit the UL grant that is used for scheduling a plurality of continuous TTIs during the duration of the single UL grant transmission.

Turning next to FIG. 19, when the UE 10 receives the UL grant (UL grant #1-3) in the unlicensed band, the UE 10 may transmit a plurality of continuous PUSCHs (PUSCH #1-3) based on the received UL grant (UL grant #1-3) in the unlicensed band (step S24-26). As shown in FIGS. 18 and 19, the UE 10 may not perform the LBT at least in intervals between the continuous PUSCHs (between the PUSCH #1 and #2, and between the PUSCH #2 and #3) before the PUSCH transmission. Although, in FIGS. 18 and 19, the UE 10 does not perform the LBT before the UE 10 transmits the PUSCH#1, the UE 10 in other embodiments may perform the LBT before the UE 10 transmits the PUSCH#1.

Thus, according to one or more embodiments of the fourth example, the BS 20 transmits a signal that includes a plurality of UL grants to the UE 10, and then the UE 10 transmits a UL data signal on the PUSCH in response to each of the plurality of UL grants. Furthermore, a TTI in which each UL data signal is transmitted is continuous. As a result, according to one or more embodiments of the fourth example, allocating a plurality of continuous PUSCHs to the single UE 10 may be capable of continuous transmission without a switch between a plurality of UEs 10.

As another example, the BS 20 may transmit DL signals to be used for keeping resources after the UL grant transmission during intervals between the continuous PUSCHs.

### Fifth Example

Embodiments of a fifth example of the present invention will be described in detail with reference to FIGS. 20A-20C. The wireless communication system 1 according to embodiments of the fifth example of the present invention may require transmission in the unlicensed bands with a maximum duration of the transmission burst (hereinafter referred to as “maximum duration”). The transmission burst may be a continuous transmission in which the LBT is not required. The maximum duration may also be called “max burst length”. That is, a duration of the transmitted signals in the unlicensed band is all or part of the maximum duration. In embodiments of the fifth example of the present invention, the maximum duration may be 4 msec. However, the maximum duration is not limited to 4 msec and may be another predetermined duration. For example, the predetermined duration may be different from each region (area or country).

As shown in FIG. 20A, after the BS 20 has performed the DL LBT, the BS 20 transmits the CSI-RS to the UE 10 during the maximum duration in the unlicensed band. Then, after the BS 20 has transmitted the CSI-RS, the UE 10 transmits the CSI feedback to the BS 20 during the maximum duration in the unlicensed band.

As shown in FIG. 20B, after the BS 20 has performed the DL LBT, the BS 20 transmits the CSI-RS to the UE 10 during the maximum duration in the unlicensed band. After the BS 20 has transmitted the CSI-RS, the UE 10 transmits the CSI feedback to the BS 20 during the maximum duration in the unlicensed band without the BS 20 performing the LBT. After the UE 10 has transmitted the CSI feedback, the BS 20 transmits the DL data signal on the PDSCH in response to the CSI feedback to the UE 10 in the unlicensed band without the BS 20 performing the LBT. After the BS 20 has transmitted the DL data signal on the PDSCH, the UE 10 transmits ACK/NACK feedback for the PDSCH transmission to the BS 20 during the maximum duration in the unlicensed band without the UE 10 performing the LBT.

As shown in FIG. 20C, after the UE 10 has performed the UL LBT, the UE 10 transmits the SRS to the BS 20 during the maximum duration in the unlicensed band. After the UE 10 has transmitted the SRS, the UE 10 transmits the UL grant to the UE 10 during the maximum duration in the unlicensed band without the UE 10 performing the LBT. After the BS 20 has transmitted the UL grant, the UE 10 transmits the UL data signal on the PUSCH in response to the UL grant to the BS 20 in the unlicensed band without the UE 10 performing the LBT. After the UE 10 has transmitted the UL data signal on the PUSCH, the BS 20 transmits ACK/NACK feedback for the PUSCH transmission to the UE 10 during the maximum duration in the unlicensed band without the BS 20 performing the LBT.

### (Configuration of Base Station)

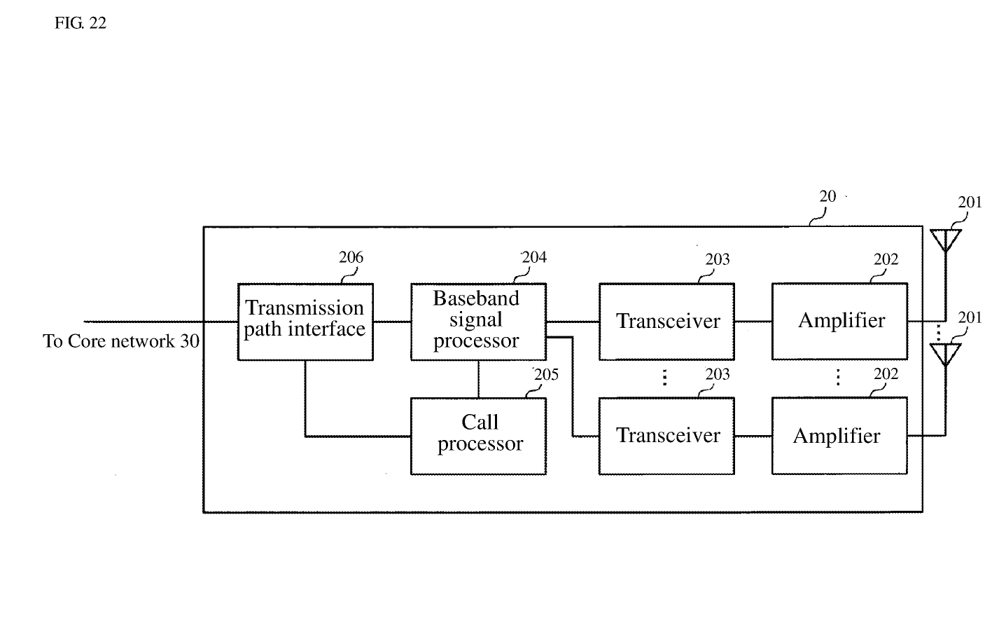

The BS 20 according to one or more embodiments of the present invention will be described below with reference to FIG. 22 a block diagram illustrating schematic configuration of the BS 20 according to one or more embodiments of the present invention. The BS 20 may include a plurality of antennas 201, amplifier 202, transceiver (transmitter/receiver) 203, a baseband signal processor 204, a call processor 205 and a transmission path interface 206.

User data that is transmitted on the DL from the BS 20 to the UE 20 is input from the core network 30, through the transmission path interface 206, into the baseband signal processor 204.

In the baseband signal processor 204, signals are subjected to Packet Data Convergence Protocol (PDCP) layer processing, Radio Link Control (RLC) layer transmission processing such as division and coupling of user data and RLC retransmission control transmission processing, MAC retransmission control, including, for example, HARQ transmission processing, scheduling, transport format selection, channel coding, inverse fast Fourier transform (IFFT) processing, and precoding processing. Then, the resultant signals are transferred to each transceiver 203. As for signals of the DL control channel, transmission processing is performed, including channel coding and inverse fast Fourier transform, and the resultant signals are transmitted to each transceiver 203.

The baseband signal processor 204 notifies each UE 10 of control information for communication in the cell by a broadcast channel. Information for communication in the cell includes, for example, UL or DL system bandwidth.

In each transceiver 203, baseband signals that are precoded per antenna and output from the baseband signal processor 204 are subjected to frequency conversion processing into a radio frequency band. The amplifier 202 amplifies the radio frequency signals having been subjected to frequency conversion, and the resultant signals are transmitted from the antennas 201.

As for data to be transmitted on the UL from the UE 10 to the BS 20, radio frequency signals are received in each antennas 201, amplified in the amplifier 202, subjected to frequency conversion and converted into baseband signals in the transceiver 203, and are input to the baseband signal processor 204.

The baseband signal processor 204 performs FFT processing, IDFT processing, error correction decoding, MAC retransmission control reception processing, and RLC layer and PDCP layer reception processing on the user data included in the received baseband signals. Then, the resultant signals are transferred to the core network 30 through the transmission path interface 206. The call processor 205 performs call processing such as setting up and releasing a communication channel, manages the state of the BS 20, and manages the radio resources.

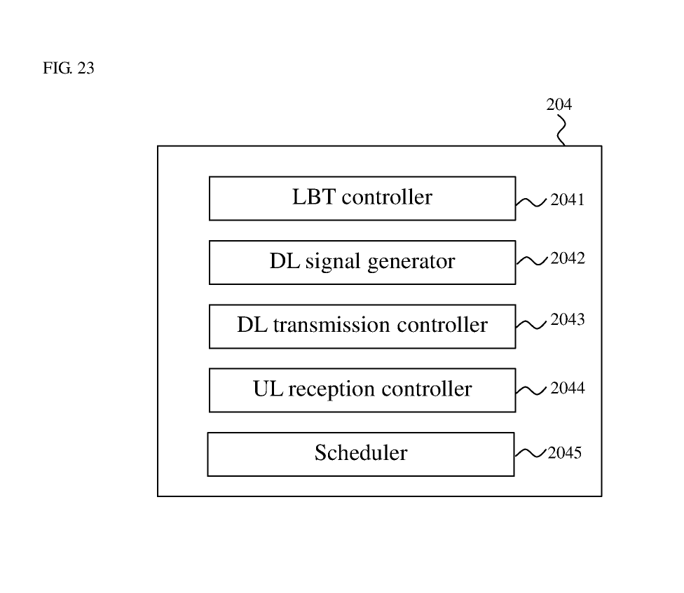

FIG. 23 is a block diagram illustrating a detailed configuration of the BS 20 according to one or more embodiments of the present invention. As shown in FIG. 23, the baseband signal processor 204 of the BS 20 may include a LBT controller 2041, a DL signal generator 2042, a DL transmission controller 2043, an UL reception controller 2044, and a scheduler 2045.

The LBT controller 2041 may perform the LBT in the channel in the unlicensed bands. When the LBT controller 2041 determines whether the channel in the unlicensed band is busy or not (idle) based on power level of detected signals, the LBT controller 2041 may output a result of the performed LBT to the scheduler 2045. The scheduler 2045 may control the scheduling of the DL data signal (PDSCH), control information (PDCCH/EPDCC), and DL reference signals such as CSI-RS and CRS. The DL signal generator 2042 may generate the DL signals such as the DL data signal, the DL control information, and DL reference signals such as CSI-RS and CRS. The DL transmission controller 2043 may transmit the DL signals. The UL reception controller 2044 may perform the reception processing for the UL signals transmitted by the UE 10.

### (Configuration of User Equipment)

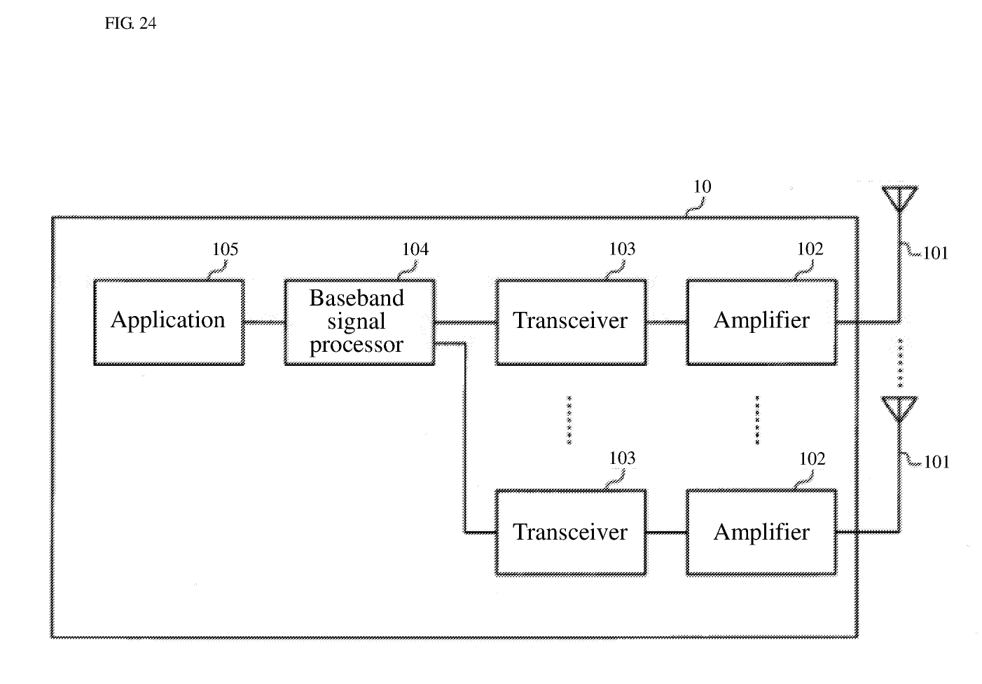

The UE 10 according to one or more embodiments of the present invention will be described below with reference to FIG. 24, a diagram illustrating an overall configuration of the UE 10. The UE 10 has a plurality of UE antennas 101, amplifiers 102, transceiver (transmitter/receiver) 103, a baseband signal processor 104, and an application 105.

As for DL, radio frequency signals received in the UE antennas 101 are amplified in the respective amplifiers 102, and subjected to frequency conversion into baseband signals in the transmission/reception sections 103. These baseband signals are subjected to reception processing such as FFT processing, error correction decoding and retransmission control and so on, in the baseband signal processor 104. The DL user data is transferred to the application 105. The application 105 performs processing related to higher layers above the physical layer and the MAC layer. In the downlink data, broadcast information is also transferred to the application 105.

On the other hand, UL user data is input from the application 105 to the baseband signal processor 104. In the baseband signal processor 104, retransmission control (Hybrid ARQ) transmission processing, channel coding, precoding, DFT processing, IFFT processing and so on are performed, and the resultant signals are transferred to each transceiver 103. In the transceiver 103, the baseband signals output from the baseband signal processor 104 are converted into a radio frequency band. After that, the frequency-converted radio frequency signals are amplified in the amplifier 102, and then, transmitted from the transmission/reception antenna 101.

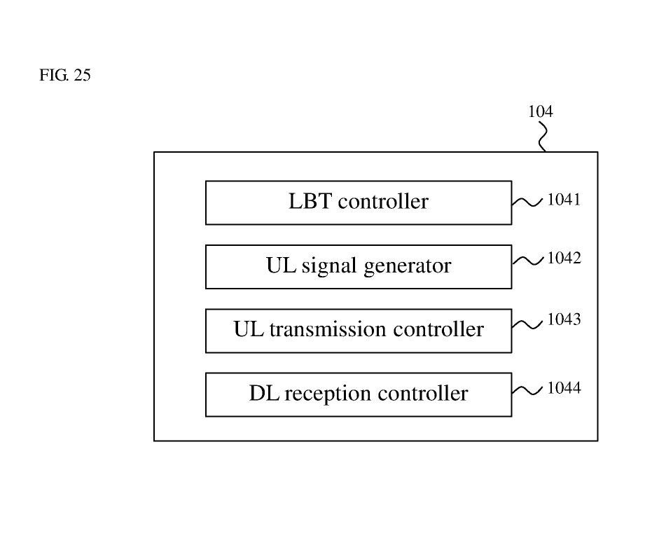

FIG. 25 is a block diagram illustrating a detailed configuration of the UE 10 according to one or more embodiments of the present invention. As shown in FIG. 25, the baseband signal processor 104 of the UE 10 may include a LBT controller 1041, an UL signal generator 1042, a UL transmission controller 1043, and a DL reception controller 1044.

The LBT controller 1041 may perform the LBT in the channel in the unlicensed bands. When the LBT controller 1041 determines whether the channel in the unlicensed band is busy or not (idle) based on power level of detected signals, the LBT controller 1041 may output a result of the LBT to the UL transmission controller 1043. The UL signal generator 1042 may generate the CSI feedback based on the CSI-RS, the PUSCH based on the UL grant, and ACK/NACK feedback for the PDSCH transmission. The UL transmission controller 1043 may transmit the UL signals based on the result of the LBT. The DL reception controller 2044 may perform the reception processing for the DL signals transmitted by the BS 20.

The above examples and modified examples may be combined with each other, and various features of these examples can be combined with each other in various combinations. The invention is not limited to the specific combinations disclosed herein.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

### EXPLANATION OF REFERENCES

1 Wireless communication system
10 User equipment (UE)
101 UE antennas
102 amplifiers
103 transceiver
104 baseband signal processor
105 application
1041 LBT controller
1042 UL signal generator
1043 UL transmission controller
1044 DL reception controller
20 Base station (BS)
21 Antenna
201 antennas
202 amplifier
203 transceiver
204 baseband signal processor
2041 LBT controller
2042 DL signal generator
2043 DL transmission controller
2044 UL reception controller
2045 scheduler
205 call processor
206 transmission path interface

What is claimed is:

1. A method of wireless communication using an unlicensed band, the method comprising:
performing, with a first transceiver, Listen-Before-Talk (LBT) in the unlicensed band;
after the first transceiver has performed the LBT, transmitting a first signal from the first transceiver to a second transceiver in the unlicensed band; and
after the first transceiver has transmitted the first signal, transmitting a second signal from the second transceiver to the first transceiver in the unlicensed band without the second transceiver performing the LBT.

2. The method according to claim 1, wherein the transmitting of the second signal is performed after a predetermined idle period from when the second transceiver receives the first signal.

3. The method according to claim 2, wherein the predetermined idle period is a Short Inter Frame Space (SIFS) defined in an IEEE 802.11 standard.

4. The method according to claim 1, further comprising:
receiving, with the second transceiver, at least one downlink (DL) data signal from the first transceiver after the second transceiver receives the first signal, wherein
the transmitting of the second signal is performed after a predetermined idle period from when the second transceiver receives a last DL data signal of the at least one DL data signal.

5. The method according to claim 1, wherein the transmitting of the second signal is performed with a short Transmission Time Interval (TTI) format.

6. The method according to claim 1, wherein when each of a plurality of second transceiver receives the first signal, the transmitting of the second signal is performed, from each of the plurality of the second transceiver to the first transceiver, without each of the plurality of second transceiver performing the LBT.

7. The method according to claim 1, wherein
the first signal is one of a channel state information reference signal (CSI-RS), a downlink (DL) data signal on a physical downlink shared channel (PDSCH), an uplink (UL) grant, or a scheduling request (SR), and
the second signal is one of channel state information (CSI) feedback, acknowledgement/negative acknowledgement (ACK/NACK) feedback for the PDSCH transmission, an UL data signal on a physical uplink shared channel (PUSCH), or an UL grant, in response to the CSI-RS, the PDSCH, the UL grant, or the SR, respectively.

8. The method according to claim 1, further comprising:
transmitting, a third signal in response to the second signal from the first transceiver to the second transceiver in the unlicensed band without the first transceiver performing the LBT.

9. The method according to claim 8, further comprising:
transmitting, a fourth signal in response to the third signal from the second transceiver to the first transceiver in the unlicensed band without the second transceiver performing the LBT.

10. The method according to claim 9, wherein
the first signal is a CSI-RS,
the second signal is CSI feedback,
the third signal is a DL data signal on a PDSCH, and
the fourth signal is ACK/NACK feedback for a PDSCH transmission.

11. The method according to claim 9, wherein
the first signal is a sounding reference signal (SRS),
the second signal is an UL grant,
the third signal is an UL data signal on a PUSCH, and
the fourth signal is ACK/NACK feedback for a PUSCH transmission.

12. The method according to claim 1, further comprising:
transmitting, from the first transceiver to the second transceiver, LBT-related information, wherein
the transmitting transmits the second signal without the second transceiver performing the LBT when the LBT-related information indicates an instruction not to perform the LBT in the second transceiver.

13. A user equipment (UE) comprising:
a receiver that receives a first signal from a base station (BS) in an unlicensed band; and
a transmitter that transmits, to the BS, a second signal in response to the first signal in the unlicensed band, without the UE performing Listen-Before-Talk (LBT).

14. The UE according to claim 13, wherein the transmitter transmits the second signal after a predetermined idle period from when the receiver receives the first signal.

15. The UE according to claim 13, wherein
the first signal is a CSI-RS, and
the second signal is CSI feedback.

16. The UE according to claim 13, wherein
the receiver receives LBT-related information from the BS, and
the transmitter transmits the second signal without the second transceiver performing the LBT when the LBT-related information indicates an instruction not to perform the LBT in the second transceiver.

17. A method of wireless communication using an unlicensed band, the method comprising:
transmitting, from a base station (BS) to a user equipment (UE), Listen-Before-Talk (LBT)-related information indicating whether or not the UE performs LBT;
determining, with the UE, whether the UE performs Listen-Before-Talk (LBT) in the unlicensed band based on the LBT-related information; and
transmitting, from the UE to the BS, an uplink (UL) data signal.

18. The method according to claim 17, wherein the LBT-related information is transmitted using at least one of a Radio Resource Control (RRC) signaling, Medium Access Control (MAC) Control Element (CE), and Downlink Control Information (DCI).

19. The method according to claim 17, wherein the transmitting transmits an uplink (UL) grant including the LBT-related information from the UE to the BS.

20. The method according to claim 17, wherein the LBT-related information indicates at least one of timing for performing LBT in the UE, a random backoff value, a Distributed Inter-frame Space (DIFS) value.
